(19) United States
(12) Patent Application Publication
(10) Pub. No.: US 2007/0296102 A1
(43) Pub. Date: Dec. 27, 2007

(54) Method for Operating an Injection Molding Machine

(76) Inventors: Werner Hofmann, Schnaittach (DE); Raimund Kram, Erlangen (DE); Klaus Oberndorfer, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/665,869

(22) PCT Filed: Oct. 11, 2005
(86) PCT No.: PCT/EP05/55146

§ 371 Date: Apr. 19, 2007

(30) Foreign Application Priority Data
Oct. 19, 2004 (DE) 10 2004 051 109.8

(51) Int. Cl. B29C 45/77

(52) U.S. Cl. 264/40.1; 425/149

(57) ABSTRACT

There is described a method for operating an injection molding machine, which comprises a forming tool, an injecting device and a digital regulating and/or control device at least for regulating and/or controlling the injecting device. When regulating and/or controlling the injecting device, a pressure regulation and/or pressure control for regulating and/or controlling the injection device is switched over subject to the reaching of a transition criterion, whereby a value is established that is used for determining the transition criterion. At least one extrapolation value is established for at least one measured value, whereupon the extrapolation value is compared with the transition criterion and the pressure regulation and/or control of the injection molding machine or is switched over to the pressure regulation and/or the pressure control.

### CROSS REFERENCE TO RELATED APPLICATIONS

This application is the US National Stage of International Application No. PCT/EP2005/055146, filed Oct. 11, 2005 and claims the benefit thereof. The International Application claims the benefits of German application No. 10 2004 051 109.8 DE filed Oct. 19, 2004, both of the applications are incorporated by reference herein in their entirety.

### FIELD OF INVENTION

The invention relates to a method for operating an injection molding machine or, as the case may be, to an injection molding machine for implementing said method.

### BACKGROUND OF INVENTION

Methods of said type are known from, for instance, the book titled “Handbuch Spritzgieβen” [meaning: Injection Molding Handbook] by Friedrich Johannaber and Walter Michaeli, published by Carl Hanser Verlag in 2001 (ISDN 3-446-15632-1). A process sequence for injection molding is described in, for example, chapter 5.2 (pages 300 to 337). Examples of various models of injection molding machines are furthermore described in chapter 8 of said book (pages 999 to 1050). In an exemplary injection molding process, plastic pellets are fed through a funnel tube to a screw. A rotational movement of the screw causes the plastic pellets to be conveyed toward the tip of the screw. The plastic pellets are melted owing to the heat dissipated when they are conveyed and by means of an electric heating means provided on a screw cylinder. A molten mass formed from the plastic pellets accumulates in front of a screw tip and pushes the screw back. Once sufficient molten material has filled up in a space in front of the screw, the screw will be pushed forward as a piston toward the screw tip. The molten mass formed from the plastic pellets can in that way be injected into a closed mold. The closed mold is a molding tool consisting of, for example, two mold sections. The speed is therein regulated in such a way that a specified pressure limit will not be exceeded. Said pressure limit relates to, for example, the pressure in front of the screw tip. The pressure in the tool (molding tool) will rise rapidly once it has been filled with the molten mass formed from the plastic pellets, which is to say with the molten plastic, because the molten material (molten plastic) will then be compressed. Switchover takes place during this phase from, for example, regulating the screw's speed to pressure regulating. It is therein of major importance for switchover of said kind to be performed reproducibly and precisely. A switchover criterion is used for switching over. The switchover criterion is a transition criterion between two types of regulating, with one type of regulating being, for example, speed regulating and a second type of regulating being pressure regulating.

Speed controlling can also be applied instead of speed regulating. It is also possible to use pressure controlling instead of pressure regulating. The transition criterion will then accordingly relate to two types of controlling.

The switchover criterion is, for example, a position of the screw, a pressure of the molten mass, or an internal mold pressure inside the molding tool. Switchover constitutes a changeover from, for instance, speed regulating to pressure regulating. To be avoided is the occurrence of a drop in pressure or of pressure spikes adversely affecting the quality of injection-molded parts. As short as possible sampling times for regulating and/or controlling can, for example, be used in order always to obtain a reproducible and precise—especially in terms of a switchover criterion, absolutely exact—changeover to pressure regulating. A possible sampling time is in the range of 100 μs, for example.

Another possibility for obtaining reproducible results is to employ interrupt controlling that is based on external comparators and an ensuing interrupt reaction with, where applicable, restarting of a regulating and/or controlling cycle.

Sampling times in the range of 100 μs are very hardware intensive. Aside from the pure computing power, all the actuators and sensors involved also have to support said times, which increases the hardware costs. On the other hand, methods having an interrupt reaction preclude using a cycle-synchronous periphery because resynchronizing is not possible here.

### SUMMARY OF INVENTION

An object of the present invention is to disclose a novel method for operating an injection molding machine with which method switching over to pressure regulating will be improved.

The object is achieved by means of a method having the features of the independent method claim. According to the invention the method can be applied to an injection molding machine as claimed in a further independent claim. The dependent claims are advantageous inventive developments.

With a method for operating an injection molding machine having in particular a molding tool, an injecting device and
a) a digital regulating device for regulating at least the injecting device, and/or
b) a digital controlling device for controlling at least the injecting device,
   while the injecting device is being regulated and/or controlled, changeover takes place, as a function of reaching a transition criterion, to pressure regulating for regulating the injecting device and/or to pressure controlling the injecting device. The injecting device serves in particular to inject, for example, heated plastic into the molding tool. The transition criterion is, for example, a switchover criterion for switching over to pressure controlling or pressure regulating, with pressure controlling or, as the case may be, pressure regulating replacing, for example, regulating or controlling the speed of the injecting device. Regulating or, as the case may be, controlling relates therein particularly to a drive for moving a means provided for injecting material into the molding tool. Said means is a screw, for example.

A value used for determining the transition criterion is ascertained with the inventive method. Said value is a pressure value, for example.

At least one extrapolation value is ascertained from at least one measured value. The extrapolation value is compared with a transition criterion, that being, for example, a switchover criterion. If the extrapolation value is equal to the transition criterion or if the extrapolation value exceeds the transition criterion, then pressure regulating and/or controlling will, for example, be brought into a major engagement. What is understood by engagement is that changeover or switchover will take place to, for instance, pressure regulating and/or pressure controlling. Alongside pressure regulating and/or pressure controlling, other types of regulating and controlling such as, for example, position controlling can also be in effect on a shared basis. Their share is, though, advantageously less than, for example, that of pressure regulating. In an advantageous embodiment switchover takes place entirely to pressure regulating and/or pressure controlling.

Using an extrapolation value makes it possible to, for example, avoid the occurrence of spikes, adversely affecting the quality of an injection-molded part, at an output of the regulating or controlling means. Exceeding of the transition criterion at the output of the regulating or controlling means can also be prevented. The regulating or, as the case may be, controlling means therein relates also to an associated device. The transition criterion relates to, for example, a pressure or a path.

According to the prior art, at the switchover instant, which is to say at the instant of changing over to pressure regulating, switching does not take place abruptly from a last actual value of the pressure to a subsequently applied pressure defined as the desired value for a subsequent-pressing phase; a profile stage is instead approached at a defined pressure gradient dp/dt, said profile stage constituting the desired value for the pressure during the subsequent-pressing phase. Owing to sampling at a clock of the regulating or controlling means, the switchover criterion cannot be exactly reproducibly evaluated. If, for example, a position value is the value of the transition criterion under consideration, then jitter will result that is the product of the current speed of, for example, the screw and the clock of the regulating or, as the case may be, controlling means. In this way it is possible in the prior art for a maximum pressure to be exceeded. The pressure relates in particular to the pressure inside the molding tool.

That problem is inventively resolved using the extrapolation value. By means of the method according to the invention the pressure curve is extrapolated during the injection phase before the switchover instant is reached. The pressure curve relates to, for example, the pressure in the molding tool, in an injection nozzle, and/or in the space in front of the screw. The method according to the invention makes a consistent pressure curve possible and avoids pressure spikes adversely affecting the item requiring to be injection-molded in the molding tool.

The jitter is minimized thanks to the method according to the invention, with said jitter relating to the pressure curve, with said pressure curve being of relevance particularly in the area of the transition criterion (for example the switchover criterion).

In an advantageous embodiment of the method according to the invention, a desired start value for the pressure is ascertained for pressure regulating and/or pressure controlling. The desired start value relates therein particularly to the start value of a gradient curve. A desired pressure value that approaches a pressure stage for example linearly is predefined with the aid of the gradient curve. The pressure stage predefines a time-limited constant desired pressure value. The desired start value is calculated in particular within a clock of the injection molding machine's regulating and/or controlling means in the region of the transition to pressure regulating or, as the case may be, pressure controlling.

A stored pressure curve, for example, is used for extrapolating. The hydraulic pressure of the screw, the pressure of the molten mass, or a pressure inside the mold can, for example, be used as the pressure. The pressure inside the mold is the pressure inside the molding tool.

An extrapolation value can be ascertained by means of, for example, a strapping table, with values reflecting a typical curve of a value such as, for example, a pressure value being filed in said strapping table.

In a further embodiment of the method the extrapolation value is ascertained by means of an interpolation function and/or a polynomial. The polynomial is for example a 3rd-, 4th-, or 5th-grade polynomial.

In a further embodiment the extrapolation value can be ascertained also by means of a master curve. For example a pressure curve is plotted over time in the master curve and provides values that are regularly assumed. Actual values of the pressure can then be compared with the master curve so that a value that will be assumed in the future can be estimated by comparing the actual values. Said comparison relates in particular to switching over to pressure regulating and/or pressure controlling. The future pressure value that can be read from the master curve ought therein not to exceed the value of the transition criterion, which is to say a maximum pressure value, for example.

The transition criterion relates to, for example, a position of the screw, a hydraulic pressure, or a pressure of the molten mass or also a pressure inside the mold.

An advantageous embodiment of the method allows different changeover criteria to be used. Examples of changeover criteria include the position of the screw, the hydraulic pressure, the pressure of the molten mass, and the pressure inside the mold.

The value used for the transition criterion is ascertained at a clock of the regulating or, as the case may be, controlling means. The clock of the regulating means is, for example, a servo clock of an electric drive. The clock of the controlling means is, for example, the clock of a controlling means provided for controlling a hydraulic drive. The regulating device can be used for, for example, regulating a drive of the injecting device. The injecting device is a piston and/or screw, for example.

A position value, for example, is used as the value for the transition criterion, which is in particular a switchover criterion having a switchover instant. A future position, for example of the screw, is therein calculated first. The position is calculated for example as follows:
sₙₑᵤ=sᵢₛₜ+vᵢₛₜ·T_{R}; where
sₙₑᵤ=new position,
sᵢₛₜ=actual position,
vᵢₛₜ=actual speed,
T_{R}=clock cycle time.

If the new position sₙₑᵤ calculated in advance is behind the switchover position s_{UM}, meaning behind the switchover criterion, then a time T_{U} up to reaching of the switchover instant, meaning up to reaching of the switchover criterion, will be calculated. The time T_{U} is calculated as follows: T_{U}=(s_{UM}−sᵢₛₜ)/vᵢₛₜ. If the position sₙₑᵤ calculated in advance is behind the switchover position s_{UM}, then changeover/switchover to pressure regulating will take place simultaneously.

A first desired value for the subsequent-pressing phase, which is to say for the phase during which changeover took place to pressure regulating, is calculated as follows:
Pₛₒₗₗ₋ₛₜₐᵣₜ=pᵤₘ+dp/dt·(T_{R}−T_{U}).

With an actual pressure value pᵢₛₜ, reference is made to, for example, a table containing the stored pressure curve of the injection phase and the pressure value pᵤₘ sought that will be assumed after the time T_{U}. Proceeding from said pressure value, decrementing or incrementing to the first pressure stage of the subsequent-pressing phase is carried out with a start gradient dp/dt.

The pressure curve in this way follows independently of the position of the switchover instant within the clock of the regulating means. The pressure curve relates to, for example, a hydraulic pressure for embodying a linear movement of the screw or the pressure in the space in front of the screw. The molding tool's internal pressure can also be used alternatively or in combination. With the method, for example the future hydraulic pressure or, as the case may be, pressure of the molten mass is first ascertained from the table of the pressure curve. That is done as described above by, proceeding from the actual pressure, reading out the pressure value after T_{R} in the table.
Pₙₑᵤ−f(pᵢₛₜ,T_{R}).

If said pressure is above the switchover pressure pᵤₘ, then the time T_{U} after which the switchover instant will be reached will be ascertained from the table
T_{U}−f(pᵢₛₜ,pᵤₘ)
and switchover to pressure regulating and/or pressure controlling will take place simultaneously.

The first desired value for the subsequent-pressing phase is ascertained therefor as follows:
Pₛₒₗₗ₋ₛₜₐᵣₜ=pᵤₘ+dp/dt·(T_{R}−T_{U}),
with pᵤₘ being in this case the fixed switchover pressure.

Here, too, the pressure curve follows independently of the position of the switchover instant within the clock of the regulating means.

If the pressure inside the mold is used as the pressure, then boundary conditions will have to be taken into account. Switchover via the pressure inside the mold serving as the switchover criterion poses complex requirements because the transition criterion (switchover criterion) and the variable requiring to be regulated (controlled) are different here. Although in this case changeover to the subsequently applied pressure takes place on reaching a specific threshold for the internal pressure, pressure regulating always operates on, for example, the hydraulic pressure or, as the case may be, pressure of the molten mass because owing to solidifying of the mold section in the tool it would technologically be to little practical effect to regulate the pressure inside the mold.

Actual curves typical (averaged) for both the pressure curve inside the mold and for the curve of the hydraulic pressure or, as the case may be, pressure curve of the molten mass will be recorded and stored when the pressure inside the mold is used.

The switchover time T_{U} is in the manner already described in detail above first read from the table for the pressure curve inside the mold and the probable hydraulic pressure/pressure of the molten mass pᵤₘ at the switchover instant is then ascertained by means of said time and the current hydraulic pressure (pressure of the molten mass).

The first desired value for the subsequent-pressing phase is again ascertained as follows:
Pₛₒₗₗ₋ₛₜₐᵣₜ=pᵤₘ+dp/dt·(T_{R}−T_{U}).

As well as using tables it is also possible to use master curves. Master curves are a further form of representing curves of values such as, in particular, pressure values.

The above-cited transition criteria can, of course, be combined and/or linked with each other.

### BRIEF DESCRIPTION OF THE DRAWINGS

Exemplary embodiments of the invention are shown in the drawing and are explained in more detail below.

FIG. 1 shows phases within an injection process,

FIG. 2 shows a pressure curve inside a molding tool,

FIG. 3 shows an instance of pressure switchover according to the prior art,

FIG. 4 shows an instance of pressure switchover according to the invention,

FIG. 5 shows a stored pressure curve,

FIG. 6 shows the ascertaining of a switchover pressure from a curve,

FIG. 7 is a simplified graphic representation of using linear pressure curves for extrapolating and determining a start value for the desired value for pressure regulating, and

FIG. 8 is a graphic dividing an injecting operation into an injection phase and a subsequent-pressing phase.

### DETAILED DESCRIPTION OF INVENTION

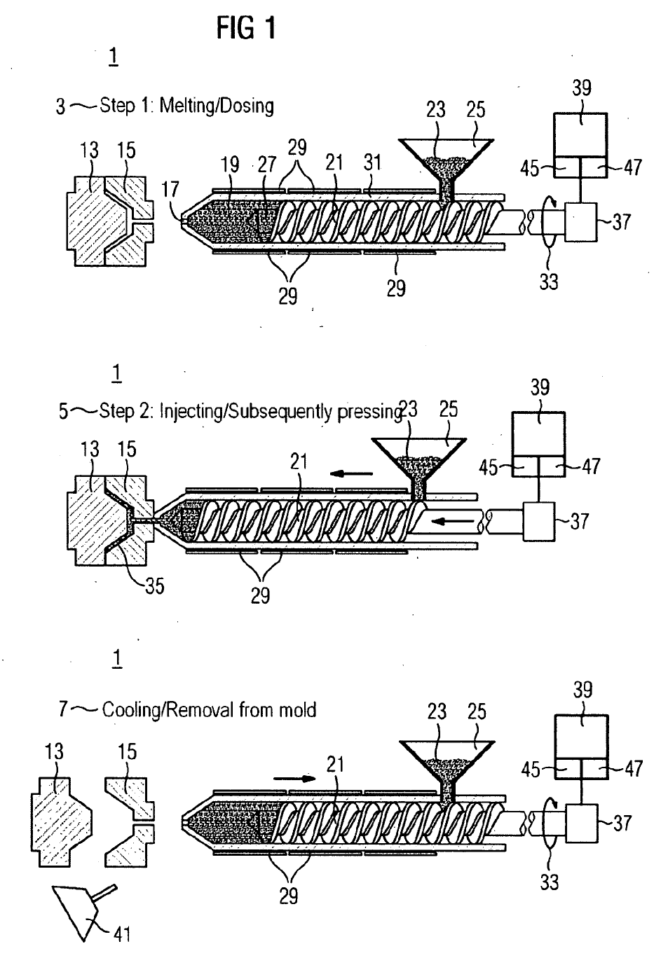

The representation in FIG. 1 shows three steps 3, 5, 7 of a molding process. The first step 3 relates to melting and dosing, the second step 5 relates to injecting and subsequent pressing, and the third step 7 relates to cooling and removal from the mold. The molding process relates to an injection molding machine 1. The injection molding machine 1 has a screw 21. The screw 21 is located in a screw cylinder 31. The injection molding machine 1 furthermore has a funnel 25. The funnel 25 can be charged with plastic pellets 23. The plastic pellets 23 can be transported into a space 19 in front of the screw through a rotational movement 33 of the screw 21. Through friction or, as the case may be, by means of an electric heating means 29, the plastic pellets are heated during transportation to form a molten mass. Through a rotational movement 33, the molten mass accumulates in a space 19 in front of the screw. The rotational movement 33 can be achieved by means of, for example, an electric drive 37. A hydraulic drive can also be used as the drive, but that is not shown in the figure. The electric drive 37 can be regulated or, as the case may be, controlled by means of, for example, a regulating device 39. The regulating device 39 has in particular a speed and/or position regulating means 45 and a pressure regulating means 47. Because molten mass accumulates in the space 19 in front of the screw, the screw 21 is pushed away from a nozzle 17. The nozzle 17 is provided for releasing the molten mass. The nozzle 17 can be moved up to a molding tool 13, 15, for which purpose for example an electric or hydraulic drive is provided, neither of which is shown in the figure. The molding tool 13, 15 has two mold sections. The first mold section 13 and the second mold section 15 are brought together to form a single mold. The first step of the molding process entails melting and dosing the material requiring to be melted. The second step 5 of the molding process relates to injecting the molten material or, as the case may be, subsequently pressing this. For injecting the molten mass, the screw 21 is moved toward the nozzle 17. As a result, molten mass penetrates into the molding tool 13, 15. A pressure is exerted subsequently at the end of the injecting operation.

Cooling and removal from the mold take place at a third step 7 of the molding process. The screw cylinder 31 is separated from the molding tool 15. The two parts of the molding tool 13 and 15 are separated so that an injection-molded item 41 is released. That step is followed again by the first step 3 of the molding process, namely melting and dosing.

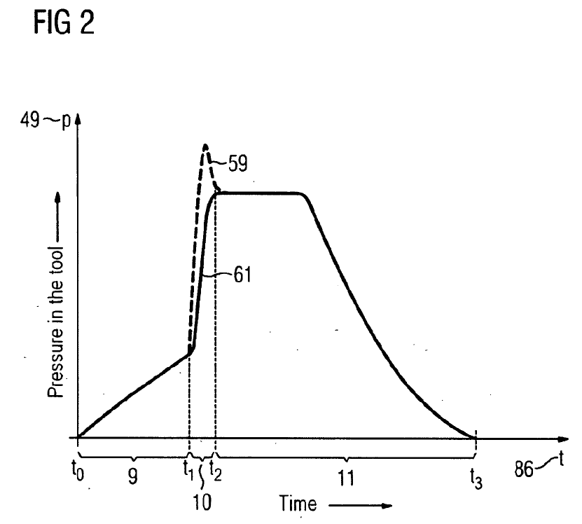

The representation in FIG. 2 shows a pressure curve p in a molding tool. The pressure relates to the pressure in the molding tool and is plotted over the time t. The pressure curve is divided into three phases. An injection phase 9 is followed by a compression phase 10 and then a subsequent-pressing phase 11. Two pressure curves are shown in the compression phase. A disadvantageous pressure curve 59, shown by means of a dashed line, and an advantageous pressure curve 61, shown by means of an unbroken line. It is clear in the representation of the disadvantageous pressure curve 59 that a pressure curve disadvantageous for an item requiring to be injection-molded will result if pressure regulating is insufficient. Material parameters such as crystallinity or anisotropy can disadvantageously be influenced by the pressure. Properties of the part being molded, which is to say properties of the injection molding, in terms of, for instance, said item's complete shaping, burring, or the formation of flash can furthermore be disadvantageously or, as the case may be, advantageously influenced during the compression phase.

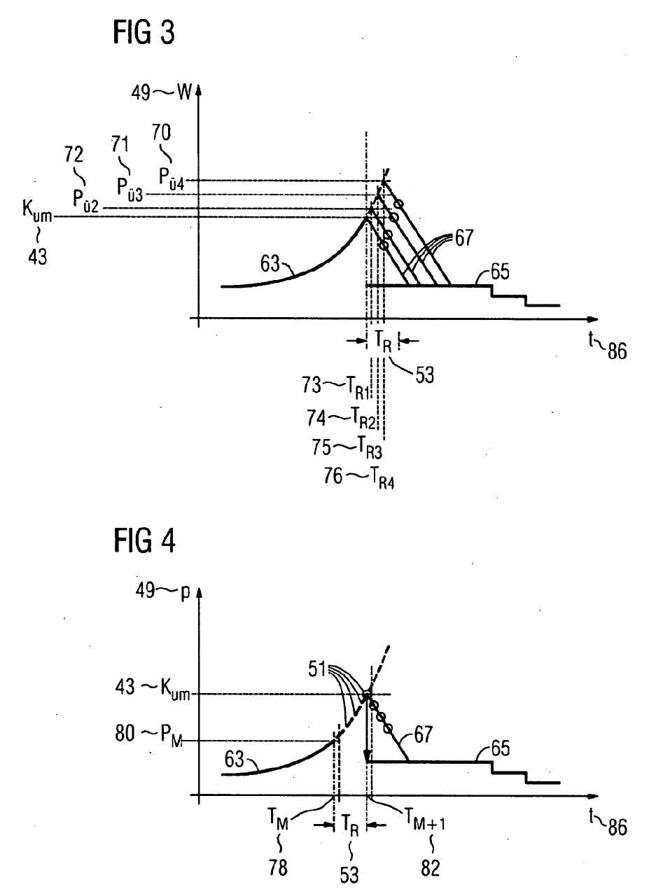

The representation in FIG. 3 shows a pressure curve 63. The pressure is, for example, the value W 49 that is used for determining a transition criterion 43, which is in particular a switchover criterion, and has been plotted over the time t. The transition criterion 43 Kᵤₘ is a pressure threshold. If the threshold, which is to say the switchover criterion 43 Kᵤₘ, is exceeded by a pressure value relating to the pressure curve 63, then switchover has to take place to pressure regulating. The pressure can hence be monitored and limited. A clock T_{R} 53 of the regulating means ideally concurs precisely with the instant at which the pressure curve 63 corresponds to the switchover criterion 43. A static pressure, for example, can be set using pressure regulating. The static pressure is predefined by means of a desired pressure value 65. By means of a pressure-time profile 67, which is a gradient curve, for example, the actual pressure value at an instant at which the switchover criterion 43 has been met will then be maintained until the at least possibly time-limited static desired pressure value 65. Switchover to the pressure-time profile 67 will take place at different instants depending on the position of the clock T_{R1} 73, T_{R2} 74, T_{R3} 75, or T_{R47} 6 of the regulating means. That will in each case produce an overpressure P_{Ü2} 72, P_{Ü3} 71, and P_{Ü4} 70. Overpressures of said type, which occur in the prior art, are to be avoided. The overpressure is the difference between P_{Ü2}, P_{Ü3} or, as the case may be, PU₄ and the value Kᵤₘ. Depending on the switchover instant, which is to say the position of the clock T_{R1} 73, T_{R2} 74, T_{R3} 75, or T_{R4} 76 of the regulating means at the switchover value Kᵤₘ, there will be an array of curves having different pressure-time profiles 67, these being embodied in such a way, for example, that the pressure p can be driven toward a profile stage, meaning the pressure value 65, by means of a defined pressure gradient dp/dt. The circles shown in the pressure-time profiles 67 indicate positions of the clock.

The representation in FIG. 4 is similar to that in FIG. 3 but exhibits a pressure switchover that has been improved with the aid of the method according to the invention or, as the case may be, in the case of an injection molding machine according to the invention (not shown). A measuring pressure P_{M} 80 is measured at a measuring instant T_{M} 78. Extrapolation values 51 are then calculated. If the extrapolation value at the instant T_{M+1} 82 is equal to or greater than the switchover criterion Kᵤₘ 43, then switchover to pressure regulating can already take place one clock after the measuring instant T_{M} 78. With the method shown in FIG. 4, the pressure curve 63 produced from measured actual pressure values is extrapolated, with the desired value being assigned according to the pressure-time profile 67 when the transition criterion, which in FIG. 4 is the switchover criterion Kᵤₘ 43, has been reached. Reaching of a first desired pressure value 65 can be followed by yet further desired pressure values having a constant rating on a time-limited basis.

The representation in FIG. 5 shows a stored pressure curve. Said stored pressure curve can be employed as a master curve 90. The curve of a pressure p 84 is shown in FIG. 5 over the time t 86. The stored pressure curve runs between, for example, a start pressure value p-Anfang 88 and an end pressure value p-Ende 90. Lying between said two values is the pressure that is used for switchover, with pressures that precede or follow said pressure lying at least within a time range 94 that is greater than the clock cycle time. The time range must therefore be selected as sufficiently large for the information needed for the transition to pressure regulating or, as the case may be, pressure controlling also to be present. A time range 94 having a length of 10 sampling times is already able to meet this requirement. The representation in FIG. 5 also shows the initial gradient 96 of the pressure curve and the final gradient 97 of the pressure curve.

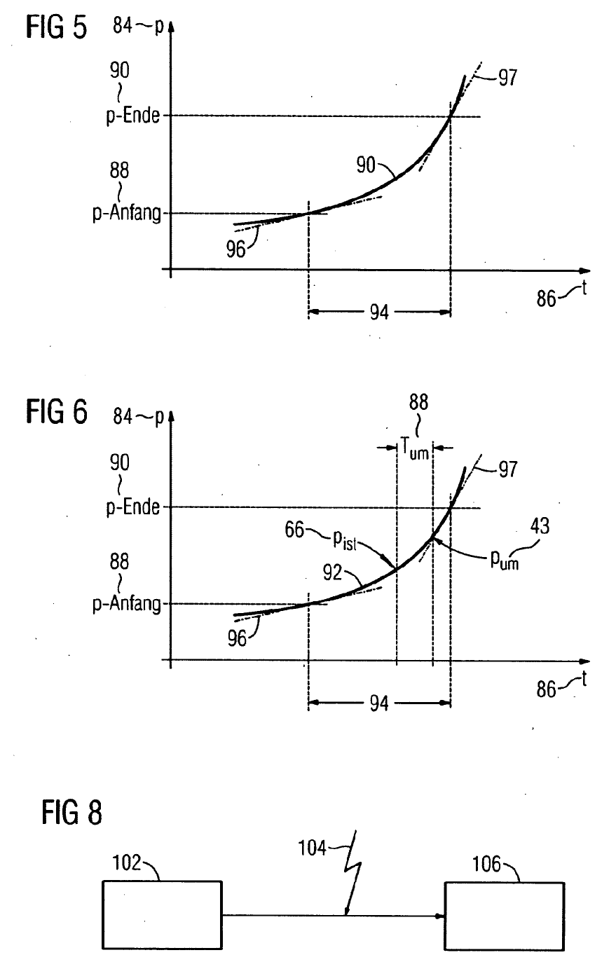

The representation in FIG. 6 follows that according to FIG. 5 and illustrates how a switchover pressure can be ascertained from a pressure curve. A pressure p is measured and is thus a current actual value pᵢₛₜ of the pressure p 84. A switchover time Tᵤₘ is then ascertained. The switchover time Tᵤₘ is the time elapsing until the switchover criterion 43, which is to say the switchover pressure pᵤₘ, is reached. The switchover time Tᵤₘ is less than a clock cycle time such as, for example, a clock of a regulating means, with said clock cycle time not being shown in FIG. 6.

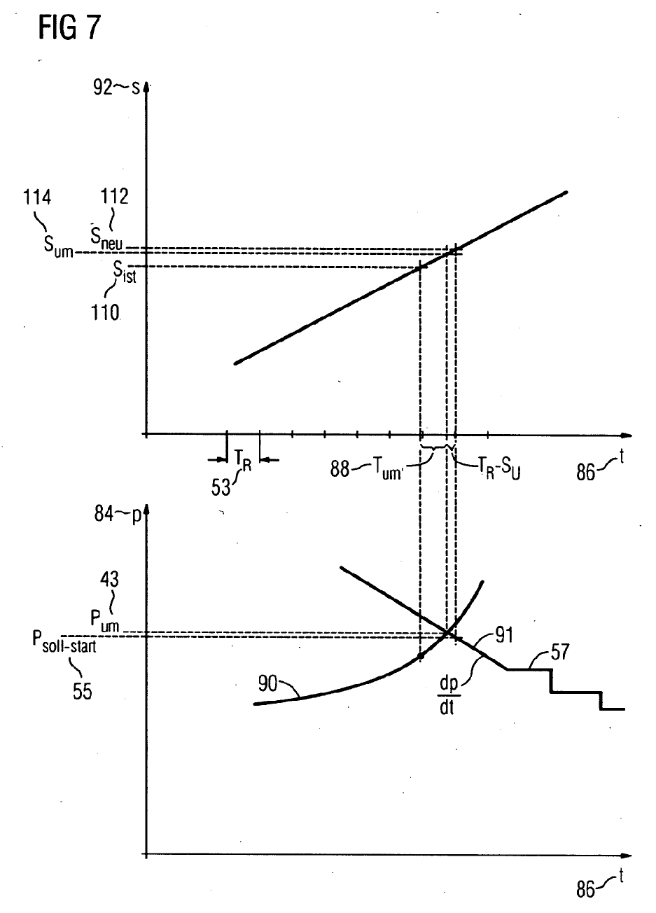

The representation in FIG. 7 shows a path position s 92 plotted over the time t 86. The path position s 92 is an example of the transition criterion and indicates, for example, the screw's path position during injecting and/or during the subsequent-pressing phase. A new path position sₙₑᵤ 112 is calculated from a current actual value of the path position sᵢₛₜ 110 at a pre-specified speed v (ds/dt=v) and from a pre-specified clock T_{R} 53. The new path position sₙₑᵤ 112 is in a range greater than a pre-specified transition criterion Sᵤₘ 114 for switching over to pressure regulating or, as the case may be, pressure controlling. The time between the actual value sᵢₛₜ 110 and reaching of the switchover value sᵤₘ 114 is the switchover time Tᵤₘ 88. The difference between the clock cycle time T_{R} 53 and the switchover time Tᵤₘ 88 gives the time used for calculating a new desired value for the pressure on a gradient curve 91. Transferring the calculated times Tun 88 and T_{R}-Tᵤₘ to a master curve 90 on which the pressure p 84 has been plotted over the time t 86 will thus give a switchover pressure pᵤₘ 43 and a start value for the desired pressure pₛₒₗₗ_{_{—}}ₛₜₐᵣₜ 55 lying on the gradient curve 91 with a gradient dp/dt. The gradient curve 91 leads to a first desired end value 57. Further reduced pressure stages can follow.

The representation in FIG. 8 is a graphic dividing an injecting operation into an injection phase 102 and a subsequent-pressing phase 106. A transition 104 to regulating or, as the case may be, controlling the injection molding machine takes place between the injection phase 102 and subsequent-pressing phase 106. Both the injection phase 102 and the subsequent-pressing phase 106 can be carried out in a regulated or controlled manner. A speed-time profile, for example, is used during the injection phase 102 for regulating and/or controlling. During the subsequent-pressing phase 106, for example pressure regulating or, as the case may be, pressure controlling is carried out that is based on a pressure-position profile. The injection phase 102 is advantageously subject to pressure limiting. Said pressure limiting advantageously has a position dependence. The subsequent-pressing phase 106 is advantageously subject to speed limiting. Volume limiting can also be applied.

1.-9. (canceled)

10. A method for operating an injection molding machine having a molding tool, an injecting device, and a controlling device to control the injecting device, comprising:
measuring a value of a transition criterion for changing a control mode of the control device based upon a transition criterion to a pressure control, wherein the controlling of the injection molding machine is based upon the pressure control;
determining an extrapolation value based upon the measured value based upon a method selected from a group consisting of:
determining the extrapolation value via a strapping table,
determining the extrapolation value based upon a interpolation function,
determining the extrapolation value based upon a polynomial, and
determining the extrapolation value based upon a master curve;
comparing the transition criterion with the extrapolated value; and
changing the control mode of the control device if the extrapolation value is equal to the transition criterion or the transition criterion is exceeded by the extrapolation value.

11. The method as claimed in claim 10, wherein the change of the control mode is made by a switching of the control mode.

12. The method as claimed in claim 10, wherein the controlling is based upon a closed loop control.

13. The method as claimed in claim 10, wherein the controlling is based upon a open loop control.

14. The method as claimed in claim 10, wherein a desired start value is determined for the pressure control.

15. The method as claimed in claim 14, wherein the desired start value relates to a gradient curve.

16. The method as claimed in claim 15, wherein the desired start value is calculated within one clock cycle of the controlling device of the injection molding machine.

17. The method as claimed in one of claims 16, wherein the clock cycle of the controlling device is used for driving an injecting device of the injection molding machine.

18. The method as claimed in one of claims 17, wherein the injecting device is a piston.

19. The method as claimed in one of claims 17, wherein the injecting device is a screw.

20. The method as claimed in claim 10, wherein the value of a transition criterion is selected from the group consisting of: a position value, a pressure value, and a time value.

21. The method as claimed in claim 10, wherein the desired values for pressure regulating are specified between a desired start value and a desired end value based upon a function.

22. An injection molding machine comprising:
a molding tool;
an injecting device;
a controlling device to control the injecting device, wherein an extrapolation value is determined based upon a measured value based upon a method selected from the group consisting of:
determination of the extrapolation value via a strapping table,
determination of the extrapolation value based upon a interpolation function,
determination of the extrapolation value based upon a polynomial, and
determination of the extrapolation value based upon a master curve,
wherein the transition criterion is compared to the extrapolated value, and
the control mode of the control device is changed when the extrapolation value is equal to the transition criterion or the transition criterion is exceeded by the extrapolation value; and
a measuring device for measuring the value of a transition criterion for changing a control mode of the control device based upon a transition criterion to a pressure control, wherein the pressure control has at least a major engagement in controlling the injection molding machine.
